(19) United States
(12) Patent Application Publication
(10) Pub. No.: US 2026/0352464 A1
(43) Pub. Date: Nov. 5, 2026

(54) VALIDATING AI AGENTS BY VERIFYING AI AGENT IDENTITY USING BLOCKCHAINS

(71) Applicant: WELLS FARGO BANK, N.A., San Francisco, CA (US)

(72) Inventors: Ravi K. Maganti, Waxhaw, NC (US); Matthew Mullin Shepherd, Charlotte, NC (US); Rameshchandra Bhaskar Ketharaju, Hyderabad (IN); Abhijit Rao, Irvine, CA (US)

(21) Appl. No.: 19/194,886

(22) Filed: Apr. 30, 2025

(51) Int. Cl. H04L 9/30

(52) U.S. Cl. CPC H04L 9/30

(57) ABSTRACT

AI agents can be verified using a digital distributed ledger-based system. The distributed ledger-based system can include one or more processors and a memory where the memory includes instructions that cause the one or more processors to receive a communication associated an artificial intelligence (AI) agent requesting to perform an action on behalf of a user. The processors can then extract a unique user identifier and an Object Identifier (OID) of the AI agent from the communication, access a distributed ledger indicating relationships between unique user identifiers and OID credentials assigned to the unique user identifiers, verify an identity of the AI agent by determining if the OID of the AI agent is correlated to the unique user identifier, and transmit a control signal to a relying party computing system comprising an indication that the AI agent is verifiable and an instruction to execute the action.

### TECHNICAL FIELD

The present disclosure generally relates to validating artificial intelligence (AI) agents. More specifically, but not by way of limitation, this disclosure relates to validating AI agents by verifying AI agent identities using blockchains.

### BACKGROUND

Software programs implementing AI and machine learning (ML) techniques to interact within a computing environment to perform tasks are often referred to as AI agents. AI agents may be developed by users or third parties and can be configured to perform tasks on behalf of users or other systems in an autonomous or semi-autonomous manner. Given the advancements in the field of AI and ML, the volume of AI agents being developed and deployed across various industries and applications has skyrocketed, with hundreds of thousands, or even more, AI agents being deployed. Verifying the identity of a user who has deployed an AI agent or verifying the identity of the AI agent itself presents unique challenges in ensuring authenticity and accountability. Unlike direct interactions with individuals, AI agents operate independently and may lack inherent mechanisms to confirm the identity or authority of the deploying user which raises concerns about security, fraud, and misuse, particularly in sensitive contexts such as legal or financial transactions.

### SUMMARY

Certain aspects of the present disclosure generally relate to validating AI agents. More specifically, but not by way of limitation, this disclosure relates to validating AI agents by verifying AI agent identities using blockchains. According to an aspect of the present disclosure, a digital distributed ledger system includes one or more processors and a memory coupled to the one or more processors. The memory includes instructions that, when executed by the one or more processors, cause the one or more processors to: receive a communication via an application of a computing device, the communication being associated with an artificial intelligence (AI) agent requesting to perform an action on behalf of a user; extract a unique user identifier and an Object Identifier (OID) of the AI agent from the communication; access a distributed ledger indicating relationships between unique user identifiers and OID credentials assigned to the unique user identifiers; verify an identity of the AI agent by determining if the OID of the AI agent is correlated to the unique user identifier in the distributed ledger; and transmit a control signal to a relying party computing system comprising an indication that the AI agent is verifiable and an instruction to execute the action.

The above system may be implemented in a cloud service executed on cloud service provider infrastructure, which may include various servers, processors, and databases. The above system can also be implemented as computer-executable program instructions stored in a non-transitory, tangible computer-readable medium or media and/or operating within a system including one or more processors or other processing device and memory.

According to an additional aspect of the present disclosure, a computer-implemented method for verifying AI agent identity includes receiving, by a processor, a communication via an application of a third-party computing device, the communication being associated with an artificial intelligence (AI) agent requesting to perform an action on behalf of a user; extracting, by the processor, a unique user identifier and an Object Identifier (OID) of the AI agent from the communication; accessing, by the processor, a distributed ledger indicating relationships between unique user identifiers and OID credentials assigned to the unique user identifiers; verifying, by the processor, an identity of the AI agent by determining if the OID of the AI agent is correlated to the unique user identifier in the distributed ledger; and transmitting, by the processor, a control signal to a relying party computing system comprising an indication that the AI agent is verifiable and an instruction to execute the action.

An additional example includes a non-transitory computer-readable medium embodying program code that is executable by one or more processors to cause the one or more processors to: receive a communication via an application of a computing device, the communication being associated with an artificial intelligence (AI) agent requesting to perform an action on behalf of a user; extract a unique user identifier and an Object Identifier (OID) of the AI agent from the communication; access a distributed ledger indicating relationships between unique user identifiers and OID credentials assigned to the unique user identifiers; verify an identity of the AI agent by determining if the OID of the AI agent is correlated to the unique user identifier in the distributed ledger; and transmit a control signal to a relying party computing system comprising an indication that the AI agent is verifiable and an instruction to execute the action.

This summary is not intended to identify the key or essential features of the claimed subject matter, nor is it intended to be used in isolation to determine the scope of the claimed subject matter. Rather, the summary is merely a simplified and non-limiting summary of the innovation that is intended to provide a basic understanding of some aspects of the innovation. The subject matter should be understood by reference to appropriate portions of the entire specification of this disclosure, any or all drawings, and each claim.

To the accomplishment of the foregoing and related ends, certain illustrative aspects of the innovation are described herein in connection with the following description and the annexed drawings. These aspects are indicative, however, of but a few of the various ways in which the principles of the innovation may be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

Various non-limiting embodiments are further described with reference to the accompanying drawings, in which:

FIG. 1 is a block diagram illustrating an example of a computing environment for verifying AI agent identity using a ledger network, according to one or more aspects of the present disclosure.

FIG. 2 is a block diagram illustrating the ledger network of the computing environment of FIG. 1, according to one or more aspects of the present disclosure.

FIG. 3 is a sequence diagram of an example process for verifying AI agent identity using a ledger network, according to one or more aspects of the present disclosure.

FIG. 4 is a block diagram illustrating an example computer-readable medium or computer-readable device including processor-executable instructions configured to embody one or more aspects of the present disclosure.

FIG. 5 is a block diagram illustrating an example system configured to implement examples of one or more aspects of the present disclosure.

FIG. 6 is a flowchart illustrating an example process for verifying AI agent identity using a ledger network, according to one or more aspects of the present disclosure.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The words “exemplary” or “example” are used herein to mean “serving as an example, instance, or illustration.” Any embodiment or design described herein as “exemplary,” or “example” is not necessarily to be construed as preferred or advantageous over other embodiments or designs.

Reference will now be made in detail to various and alternative illustrative examples and to the accompanying drawings. Each example is provided by way of explanation, and not as a limitation. It will be apparent to those skilled in the art that modifications and variations can be made. For instance, features illustrated or described as part of one example may be used on another example to yield a still further example. Thus, it is intended that this disclosure include modifications and variations as come within the scope of the appended claims and their equivalents.

### Illustrative Example of Verifying AI Agent Identity Using Blockchains

One illustrative example of the present disclosure includes a verification server that can receive a communication. The communication can be associated with an AI agent where the communication includes a request signifying that the AI agent is requesting to perform an action on behalf of a user. Prior to allowing the AI agent to perform the action on behalf of the user, the verification server can detect the communication and extract information from the communication to verify an identity of the AI agent. More specifically, the request can include a unique user identifier and an AI agent object identifier (OID). The unique user identifier can be a randomly generated alphanumeric identifier that is purportedly assigned to the user who provisioned the AI agent and the AI agent OID can be a globally unique identifier used to reference specific objects, attributes, or concepts in a standardized format and be generated by a trusted authoritative body (e.g., a certification authority) based on standardized protocols such that AI agent OID may not be duplicated for additional AI agents.

After extraction of the AI agent OID and the unique user identifier, the verification server can access a distributed ledger. The distributed ledger can include one or more blockchains indicating relationships between unique user identifiers, AI agent OID, user profile attributes, AI agent attributes, and additional attributes and information thereto. The blockchains can serve as comprehensive, immutable, secure, trusted records that the verification server can rely on to authorize or deny AI agent requests to perform actions on behalf of users. The blockchains are comprehensive because each time information associated with a block in the chain changes, a new block is added. For instance, if a user has provisioned an AI agent having a specific AI agent OID, an entry indicating the permissions and identity of the AI agent is added to the chain. This entry can provide proof of identity of the AI agent to the verification server. However, if the user later decides to de-commission the AI agent or otherwise change one or more attributes of the AI agent, the blockchain adds a new entry to the ledger with the changed information. Blocks at the front of the chain provide the most recent and accurate information and supersede previous blocks. Thus, the blockchains create a historical record indicating how AI agent attributes change over time. Additionally, the blockchains are immutable as they cannot be unilaterally changed or modified once they are incorporated into the blockchain, and they are secure because their content is encrypted. The blockchains are trusted because they are network-managed, distributed, and decentralized meaning the blockchains may be replicated, stored, and monitored on various nodes of a network without any one entity acting as a central authority for the information stored on the blockchain.

Continuing with the illustrative example, the verification server can access the blockchains and verify an identity of the AI agent by determining if information in the request received from the AI agent is correlated to the unique user identifier and AI agent OID in the distributed ledger. Upon verification of the AI agent identity, the verification server can transmit a control signal to a relying party computing system comprising an indication that the AI agent is verifiable and comprising an instruction to execute the action specified in the communication. Otherwise, if the AI agent is not verifiable, the verification server can block the communication and transmit a response signal back to the computing device originating the communication indicating the request was denied.

Examples of the present disclosure can provide numerous advantages over conventional approaches to protecting users. As previously mentioned, AI agents may be developed by users or third parties and can be configured to perform tasks on behalf of users or other systems in an autonomous or semi-autonomous manner. Usage of blockchains can serve as extensive records about AI agents, actions performed by AI agents, and authorizations provided by users provisioning such AI agents. Blockchains can be more accurate and reliable than any single entity's independent records since the blockchains are maintained and constantly updated by a collective of entities. In addition, the blockchains provide uniformity of information with respect to how computing systems verify AI agent identity since all computing systems with access to the blockchains can screen AI agent requests based on the same set of data.

While certain embodiments are described, these embodiments are presented by way of example only and are not intended to limit the scope of protection. The apparatuses, methods, and systems described herein may be embodied in a variety of other forms. Furthermore, various omissions, substitutions, and changes in the form of the example methods and systems described herein may be made without departing from the scope of protection. Further details regarding the systems and methods are provided below in relation to the drawings.

### Example Systems for Verifying AI Agent Identity Using Blockchains

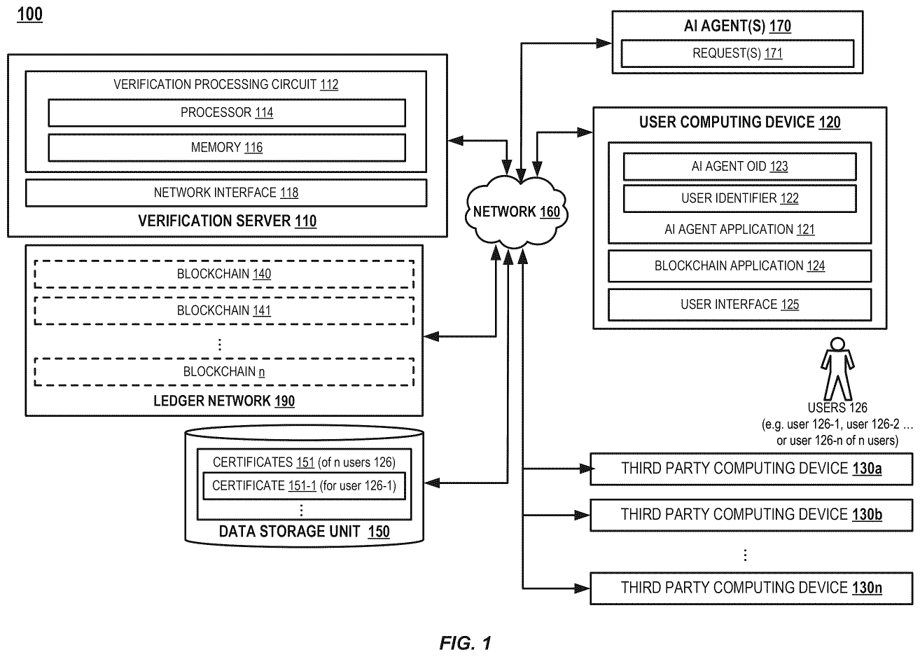

Referring now to the drawings, FIG. 1 is a block diagram illustrating an example of a computing environment 100 for verifying AI agent identity using a ledger network, according to one or more aspects of the present disclosure. The computing environment 100 includes a verification server 110, a user computing device 120, a plurality of third party computing device(s) 130a-130n, a ledger network 190, a data storage unit 150, and AI agent(s) 170. The verification server 110, user computing device 120, third party computing device(s) 130a-130n, and AI agent(s) 170 may communicate with each other or with the ledger network 190 or data storage unit 150 via network 160.

In certain embodiments, the user device computing device 120 includes an AI agent application 121, a blockchain application 124, and a user interface 125. In a distributed computing environment, such as computing environment 100, a multitude of user computing devices, such as user computing device 120, may be provided and connected via network 160 to one or more of the verification server 110, the ledger network 190, the data storage unit 150, or the third party computing device(s) 130a-130n. That is, user computing devices, such as user computing device 120, may be associated with users 126 (e.g., user 126-1, user 126-2, . . . , user 126-n of n users 126) each operating or otherwise being associated with a respective user computing device. Users 126 may represent individuals or groups of individuals, third party systems, business units, or entities having a having a technical and/or business relationship with an enterprise hosting the verification server 110 (including the ledger network 190 and data storage unit 150) or with entities associated with one or more third party computing device(s) 130a-130n.

In one example, the entity responsible with hosting the verification server 110 may be the same entity (e.g., associated with) as one or more third party computing devices, such as one or more of third party computing device 130a, 130b, and so on. In other examples, one or more of third party computing device 130a, 130b, and so on may be associated with a separate entity than the entity responsible with hosting the verification server 110. For instance, verification server 110 may be associated with a financial institution and third party computing device 130a may be associated with a credit bureau agency. In this example, a user of users 126 may have provisioned an AI agent (e.g., one of AI agent(s) 170) to freeze/unfreeze their credit report upon satisfaction of certain criteria (e.g., unfreeze the credit before purchasing a vehicle where a credit check would need to be performed). The AI agent, acting on behalf of the user of users 126 may be verified, by verification server 110 via ledger network 190, and then subsequently perform such an action with third party computing device 130a on behalf of the user. In some instances, the one or more of third party computing device 130a, 130b may be referred to herein as a “relying party computing device.”

A specific user (e.g., user 126-1) may interact, via user interface 125, with the blockchain application 124 and the AI agent application 121 of the user computing device 120. User interface 125 enables user 126-1 to interact with the user computing device 120. The user interface 125 may be a touch screen interface, a voice-based interface, or any other interface that allows user 126-1 to provide input and receive output from one or more applications on the user computing device 120. For instance, user 126-1 associated with user computing device 120 may interact with the AI agent application 121 to deploy an AI agent having an AI agent OID 123 and user identifier 122. Similarly, user 126-1 associated with user computing device 120 may interact with the blockchain application 124 to view and add new entries into the ledger network 190 and the associated blockchains (e.g., blockchain 140a, blockchain 140b, . . . , blockchain 140n) that form the ledger network 190.

In one embodiment, user 126-1 interacts via the user interface 125 with AI agent application 121 to generate and deploy (i.e., provision) an AI agent. In some implementations, generating and deploying an AI agent via AI agent application 121 can involve interacting with a third-party website where the third-party website is configured to generate suitable software to implement an AI agent to execute a particular tasks or group of tasks for user 126-1. Example AI agents include, but are not limited to, personal finance AI agents configured to execute financing tasks on behalf of a user, scheduling AI agents configured to access and organize a digital calendar associated with a user, research AI agents configured to serve a user in a “chatbot” manner to answer questions a user may have, and so on.

As part of the AI agent provisioning process, user 126-1 interacting via AI agent application 121 can generate an AI agent OID 123. In the context of distributed ledger technologies and the computing environment 100 of FIG. 1, OIDs, such as AI agent OID 123, may refer to a globally unique identifier used to reference specific objects, attributes, or concepts in a standardized format. The AI agent OID 123 may be generated by a trusted authoritative body (e.g., a certification authority) based on standardized protocols such that AI agent OID 123 may not be duplicated for additional AI agents and users. In some examples, the AI agent OID 123 may be a reference that points to a storage location storing certificates 151. The reference may be in the form of a Uniform Resource Namespace (URN) or a Uniform Resource Locator (URL) pointing to a data storage unit (e.g., data storage unit 150). The certificates 151 stored in data storage unit 150 accessible via the AI agent OID 123, can include descriptive information about the AI agent associated with the AI agent OID 123 and/or descriptive information about the user who provisioned the AI agent. Similar to the AI agent OID 123, the certificates 151 may be published through the services of a certification authority. The certificates may also include a public key information that can be used by digital signature verification software operating within verification server 110 to verify digital signatures and prove authenticity of AI agents and users. Successful verification of digital signatures can prove provide proof that request(s) 171 received from AI agent(s) 170 have not been tampered with and can provide proof of authenticity in the request (e.g., that the users 126 have authorized and provisioned the AI agent(s) 170 to perform actions on their behalf).

Similarly, as part of the AI agent generation and deployment user 126-1 interacting via AI agent application 121 can generate a user identifier 122. Just as AI agent OID 123 is generated to identify the generated AI agent, user identifier 122 is generated by AI agent application 121 to identify the particular user (e.g., user 126-1) who generated the AI agent. Generation of both the AI agent OID 123 and the user identifier 122 establishes a linkage between the user 126-1 and the generated AI agent. In some examples, each of the user identifier 122 and the AI agent OID 123 can be a randomly generated alphanumeric identifier. In addition, the communication from the user computing device 120 provisioning the AI agent having an AI agent OID 123 and user identifier 122 can be cryptographically signed with a digital signature of the user.

In addition to generation of the AI agent OID 123 and the user identifier 122, additional data may be generated by AI agent application 121. For instance, AI agent application 121 may generate data describing a particular role or context of the AI agent thereby limiting the particular actions the AI agent is able to perform on behalf of the user 126-1. AI agent application 121 may also generate timestamp information specifying a particular date and time when the AI agent was provisioned. Other non-limiting examples of data generated by the AI agent application 121 can include a data domain permission (e.g., the AI agent is only authorized to access certain types of data when performing an action), a threshold limitation (e.g., in the context of financial transactions, the AI agent is only authorized to conduct financial transactions that satisfy a predetermined threshold set by the user 126-1), user contact information, user address location, a name and/or label associated with the AI agent, and so on.

After AI agent provisioning by AI agent application 121, the user 126-1 can deploy the AI agent via blockchain application 124. In this context, deploying the AI agent can refer to the user 126-1 authorizing the AI agent to perform actions on behalf of the user 126-1 in accordance with the authorization and verification parameters set by the AI agent application 121. In more detail, blockchain application 124 may transmit a communication via network 160 to ledger network 190 that user 126-1 has generated and deployed a new AI agent. Ledger network 190 may process such communications including newly generated and deployed AI agents generate a new block within one or more blockchains of the ledger network 190.

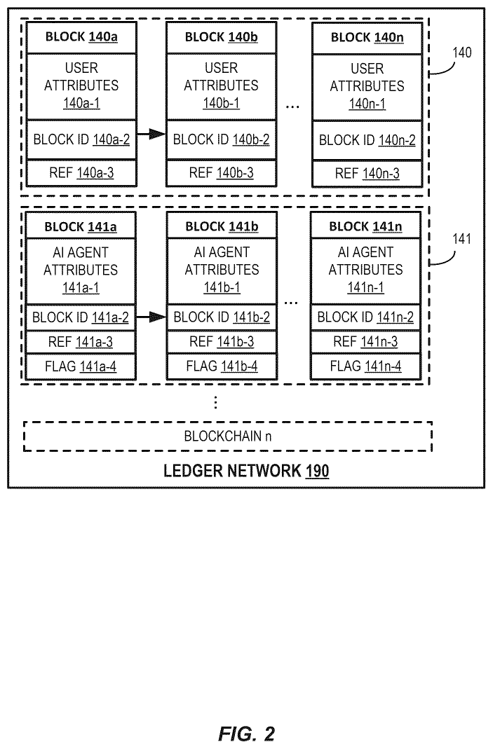

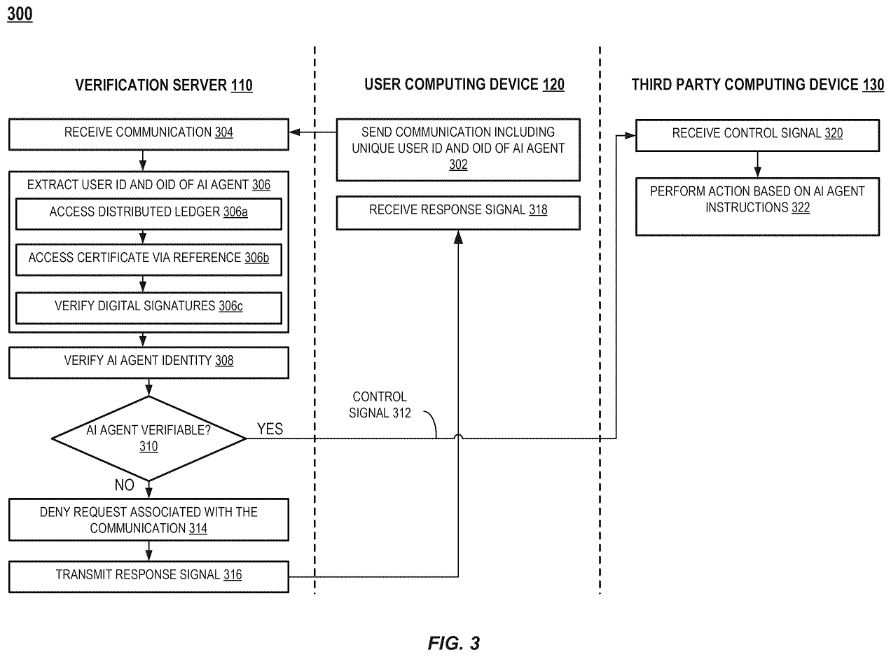

As described in more detail with respect to FIG. 2, each blockchain of ledger network 190 (e.g., blockchain 140, blockchain 141,. blockchain n) can include entries, referred to as blocks, specifying information received from user computing devices during the AI agent provisioning process. Upon receipt of the signal from user computing device 120, ledger network 190 may generate one or more new entries (e.g., new blocks) within a particular blockchain of ledger network 190 where the new block represents a recordation of the details associated with the new AI agent. More specifically, within the ledger network 190 is one or more blockchains 140, 141, n. In some examples, blockchains 140, 141, n may be referred to as “ledgers,” “distributed ledgers,” “chains,” or “digital ledgers.” The blockchains 140, 141, n each includes a series of sequential, immutable entries, referred to as “blocks.” Each block is distinct from the block before it, but linked to the prior block via a block ID, such as a hashed pointer, thereby creating sequential chain of blocks or “blockchain.” The blockchains 140, 141, n can serve as trusted records that can be relied above by verification server 110 and third party computing devices 130a-n to validate request(s) 171 received from AI agent(s) 170 and manage negative AI agent behavior, as discussed in more detail below with respect to FIGS. 2 and 3.

Computing environment 100 also include verification server 110. Verification server 110 can be configured to process such request(s) 171 received directed from pre-provisioned AI agents (e.g., one or more request(s) 171 received from AI agent(s) 170). To process such request(s) 171, verification server 110 includes verification processing circuit 112 having at least a processor 114 and a memory 116. Depending on the exact configuration and type of sever configuration, the at least one memory 116 may be volatile, such as RAM, non-volatile, such as ROM, flash memory, etc., or a combination thereof. Non-limiting examples of processors usable to implement processor 114 can include a microprocessor, an application-specific integrated circuit (ASIC), a field-programmable gate array (FPGA), or any other suitable processing device. In some implementations, verification server 110 can include more than one processor, more than one memory, and any combination thereof. Non-limiting examples of the network interface 118 include an Ethernet network adaptor, a wireless network adapter, a modem, Wi-Fi adapter, Bluetooth adapter, near field communication (NFC) receiver and transmitter, and any other known wired or wireless data transmission system.

Also included in computing environment 100, and as previous introduced above, can be data storage unit 150. Data storage unit 150 may be a remote, network-accessible storage component (as shown in FIG. 1). In other embodiments, data storage unit 150 may be local storage included, for example, within verification server 110. Data storage unit 150 may store certificates 151 associated with n users 126. Certificate 151-1 may be stored in data storage unit 150 and be associated with user 126-1, certificate 151-2 may be stored in data storage unit 150 and be associated with user 126-2, and so on. Certificates 151 may be issued by a trusted authority, such as a certification authority. In some examples, the enterprise responsible for managing the verification server 110 and/or the ledger network 190 can issue certificates 151. Certificates 151 may be access during runtime when processing a request(s) 171 to verify help verify AI agent identity. More specifically, certificates 151 may include information about the respective user and/or about the respective AI agent for which the certificate was issued for. For instance, the certificates 151 can each include a public key associated with a particular user (e.g., certificate 151-1 can include public key for user 126-1). During runtime and AI agent verification, verification server 110 access the appropriate certificates 151 based on the request(s) 171 received from an AI agent(s) 170 and verify that the request(s) 171 is signed using the same public key and digital signature as the appropriate certificate to verify the authenticity and identity of AI agent(s) 170.

FIG. 2 is a block diagram illustrating the ledger network 190 of the computing environment 100 of FIG. 1, according to one or more aspects of the present disclosure. As previously described with respect to FIG. 1, within ledger network 190 can be one or more blockchains. For example, ledger network 190 includes blockchain 140, blockchain 141,. blockchain n. Each blockchain included within ledger network 190 can include a series of sequential, immutable entries referred to as “blocks.” For example, blockchain 140 includes blocks 140a, 140b, . . . , 140n and blockchain 141 includes block 141a, 141b, . . . , 141n. Each block in the respective blockchains includes a block ID (e.g., block ID 140a-2, block ID 140b-2, . . . , block ID 140n-2 for blockchain 140 and block ID 141a-2, block ID 141b-2, . . . , block ID 141n-2 for blockchain 141). As shown in FIG. 2, the block IDs link subsequent blocks to the preceding block. The block IDs may be implemented as a hashed pointer. Linking the blocks together in the respective blockchains creates a sequential chain of blocks. Each of blockchain 140, 141, . . . , n can serve as trusted records that can be relied upon by the verification server 110 to validate request(s) 171 from AI agent(s) 170. The blockchains 140, 141, . . . , n can be updated responsive to new communications received from user computing device 120 via blockchain application 124, for example.

In one implementation, blockchain 140 can be referred to as a “user profile blockchain.” That is, during the AI agent provisioning process, the ledger network 190 can incorporate a new block into the user profile blockchain comprising information associated with the user provisioning the AI agent. More specifically, a new user interacting with the AI agent application 121 for the first time, will go through a validation process where upon completion of the validation process, blockchain application 124 will create a new entry (e.g., block) in the user profile blockchain representing the user profile for the newly registered user.

In more detail, and as shown in blockchain 140, each block in the user profile blockchain includes user attributes 140a-1, 140a-2, . . . , 140a-n. The user attributes uniquely identifies the particular user for which the block is created for. The user attributes can include user profile information and a digital signature. The user profile information can be associated with an account maintained by the user with the enterprise hosting the verification server 110 and can include a username, user address, user contact information, and a user identifier (e.g., user identifier 122). As previously described with respect to FIG. 1, the user identifier 122 can be a randomly generated alphanumeric identifier associated with the particular user such that no two users have the same user identifier 122. Each block in the blockchain 140 includes a block ID, as previously introduced, and a reference (e.g., ref 140a-3, 140b-3, . . . , 140n-3). The reference, which can be a URN, URL, or other suitable object locator, may point to the data storage unit 150 location storing certificates 151 associated with the user. The certificate associated with the user of each block can be digitally signed with a cryptographic digital signature. During runtime where the verification server 110 is verifying the identity of the AI agent(s) 170 and corresponding request(s) 171, the verification server can evaluate the request(s) 171, which may include a digital signature, against the digital signature in the certificate associated with a particular user to determine a match. Further, each time at least one field of a block of blockchain 140 changes (e.g., at least one of the user attributes, the reference changes, etc.), a new block can be added to the blockchain 140.

In one implementation, blockchain 141 can be referred to as an “AI agent blockchain.” That is, during the AI agent provisioning process, the ledger network 190 can incorporate a new block into the AI agent blockchain comprising information associated with the AI agent. That is, once a new AI agent has been provisioned by a user via AI agent application 121, the ledger network 190 can incorporate a new block into the AI agent blockchain.

Each block in blockchain 141 (e.g., blocks 141a, 141b, . . . , 141n) includes similar fields as the blocks in blockchain 140. For instance, each block in blockchain 141 includes AI agent attributes 141a-1, 141a-2, . . . , 141a-n. Similar to blockchain 140, the AI agent attributes uniquely identifies information associated with particular AI agents for which the block is created. The AI agents attributes can include AI agent authorizations, creation times, IP address associated with a location where the AI agent was created (e.g., as associated with the user computing device), actions the AI agent may perform, a name or label for the AI agent, and so on. The AI agent attributes may also include identifying information such as a digital signature associated with the user that provisioned the AI agent and the user identifier 122. In addition, and similar to blockchain 140, each block in the blockchain 141 includes a block ID, as previously introduced, and a reference, where the reference points to the data storage unit 150 location storing certificates 151 associated with the user. That is, some references in each blockchain 140, 141 may point to the same certificate. Moreover, each time at least one field of a block of blockchain 141 changes a new block can be added to the blockchain 140.

Thus, during AI agent provisioning, new blocks may simultaneously be generated for each of blockchain 140 and blockchain 141 where the blocks may be linked (e.g., correlated) based on each block in respective blockchains including similar identity information, such as a reference to the same certificate of certificates 151, a same unique user identifier 122, or some other form of similar identity information linking a specific user to a provisioned AI agent.

Ledger network 190 also can include additional blockchains as depicted by blockchain n. For instance, another blockchain may be formed within ledger network 190 that provides an immutable record of all transactions/actions performed by AI agents on behalf of users. Such a blockchain may be referred to as a “AI agent transaction blockchain.” Each block in the AI agent transaction blockchain can include a timestamp, a transaction description (include fields identifying the third party computing system for which the transaction occurred at), a block ID, and so on. The AI agent transaction blockchain may be accessible and usable by the verification server 110 to ensure the provisioned AI agents are performing actions correctly as specified and authorized by the provisioning users.

The verification server 110 can use the ledger network 190, including blockchains 140, 141, . . . , n in various processes, for example, the process shown in FIG. 3. Other examples can include more steps, fewer steps, different steps, or a different order of the steps than is shown in FIG. 3.

Referring now to FIG. 3, FIG. 3 is a sequence diagram 300 of an example of a process for verifying AI agent identity using a ledger network, according to one or more aspects of the present disclosure. As shown in FIG. 3, sequence diagram 300 begins at block 302 when a user computing device 120 sends a communication. The communication can include a unique user identifier 122 and an AI agent OID 123. In some examples, the communication can be associated with an AI agent(s) 170 submitting a request(s) 171 to perform an action on behalf of a user.

At block 304, the verification server 110 can receive the communication. As described with respect to FIG. 1, the communication can be transmitted over network 160. The verification server 110 can receive the communication via network interface 118. The verification server 110 can then process the communication using verification processing circuit 112 which includes a suitable processor 114 and memory 116 configured to process such communications.

At block 306, the verification processing circuit 112 can extract the user identifier 122 and AI agent OID 123 from the communication. At block 306a, the verification server can access a distributed ledger. The distributed ledger can be the distributed ledger 190 as described with respect to FIGS. 1 and 2. The verification server can identify, by evaluating the blockchains within distributed ledger 190, an entry associated with the communication by matching the user identifier 122 and the AI agent OID 123 with respective user attributes and AI agent attributes from respective blockchains (e.g., from the user profile blockchain 140 and the AI agent blockchain 141). More specifically, the verification server can view the distributed ledger 190 and determine whether the user identifier 122 and the AI agent OID 123 in the communication is correlated to one or more blocks of the one or more blockchains in the distributed ledger 190. For instance, the communication may contain information indicating that the AI agent wants to perform a financial transaction on behalf of a user. The verification server may match the communication from the AI agent to one or more blocks in the distributed ledger 190 to identify a block in blockchain 141 that is correlated to the communication. The verification server may evaluate the AI agent attributes from the block in blockchain 141 to determine that the AI agent is verifiable based on an AI agent attribute that matches the action described in the communication.

In some examples, the verification server may perform further verification of the AI agent identity such as described at block 306b, where the verification server 110 can access a certificate. That is, the verification server 110 can identify one or more blocks in the blockchains of the distributed ledger 190 and access a certificate based on the reference in the blocks. Then, verification server 110 may extract the certificate from certificates 151 in data storage unit 150. At block 306c, the verification server 110 may verify the digital signatures may verify that the communication received the AI agent(s) 170 and the extracted certificate extracted from the data storage unit 150 are signed with the same digital signature.

At block 308, the verification server 110 can verify the AI agent identity. For instance, if the verification server 110 determines that the communication received from the AI agent(s) 170 is correlated to one or more entries in the distributed ledger 190 (e.g., by virtue of an analysis of the fields of the blocks or via extraction of certificates and digital signal verification) the verification server 110 can determine that the communication is authenticate and the AI agent identity is verified. Alternatively, if the verification server 110 determines that the communication received from the AI agent(s) 170 is not correlated to one or more entries in the distributed ledger 190 the verification server 110 can determine that the communication is not authenticate and therefore AI agent identity is not verified.

At block 310, if the AI agent is not verifiable, sequence diagram 300 proceeds to block 314 where verification server 110 denies the request associated with the communication, and transmits, at block 316, a response signal to the user computing device 120. At block 318, the user computing device 120 receives the response signal. The response signal can provide an indication to the user computing device 120 that the request in the original communication was denied. The response signal can provide real-time feedback to a user of the user computing device. Such real-time feedback can assist a user with identifying instances of fraudulent activity in their account where an AI agent may attempt to perform a malicious action without authorization from the user.

At block 310, if the AI agent is verifiable, verification server 110 generates and transmits a control signal 312. The control signal 312 includes information specifying that the AI agent is verified as well as instructions to perform an action as specified in the original communication.

At block 320, the third party computing device 130 receives the control signal 220, and at block 322, the third party computing device 130 performs the action based on the instructions contained in the control signal. As previously described, users may provision AI agents to perform various automated tasks on their behalf. Non-limiting examples of AI agents can include fraud detection AI agents configured to implement AI algorithms to analyze vast quantities of transactional data to identify anomalies and patterns indicative of fraudulent activity in real-time, credit risk AI agents configured to analyze borrower profiles to predict default probabilities, portfolio management AI agents configured to automate portfolio management and execute personalized investment strategies, research AI agents configured to provide real-time analytics and advice to users, and so on.

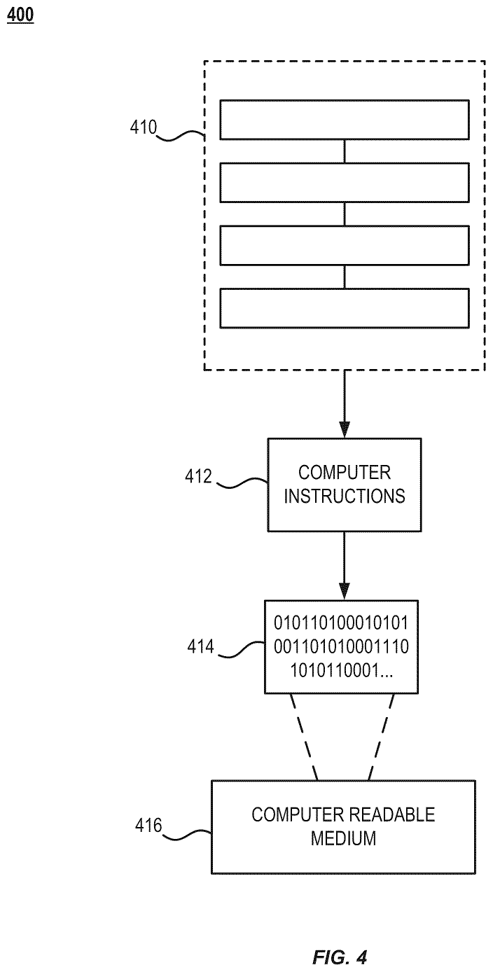

One or more of the aspects of the present disclosure include a computer-readable medium including microprocessor or processor-executable instructions configured to implement one or more embodiments presented herein. FIG. 4 is a block diagram 400 illustrating an example computer-readable medium or computer-readable device including processor-executable instructions configured to embody one or more of the aspects set forth herein. As illustrated in FIG. 4, block diagram 400 includes a computer-readable medium 416. Computer-readable medium 416 can include a CD-R, DVD-R, flash drive, a platter of a hard disk drive, and so forth, on which computer-readable data 414 is encoded and stored. The computer-readable data 414, such as binary data including a plurality of zero's and one's as illustrated, in turn includes a set of computer instructions 412 configured to operate according to one or more of the principles set forth herein.

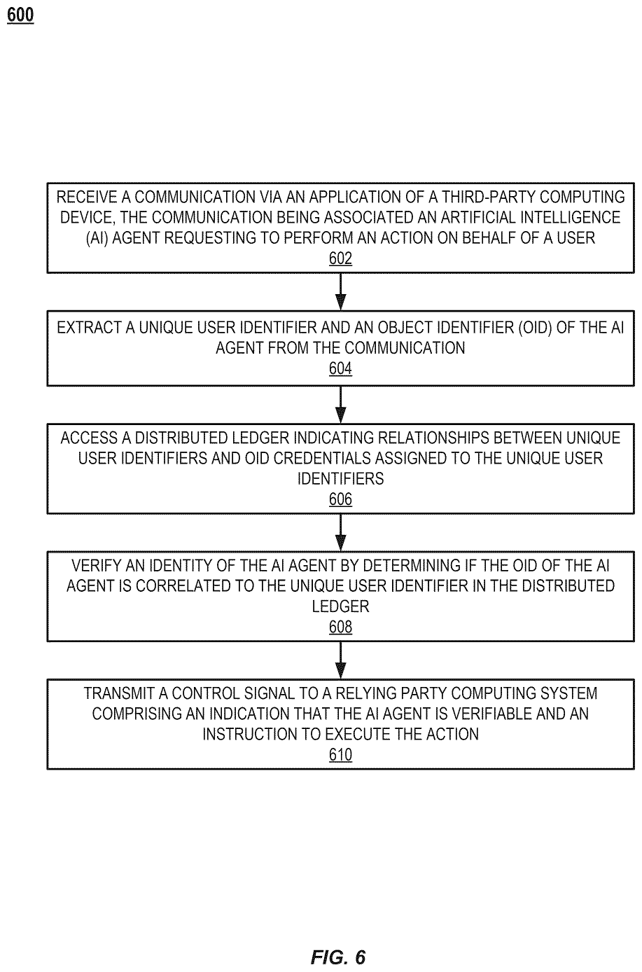

In the illustrated implementation of FIG. 4, the set of computer instructions 412 (e.g., processor-executable computer instructions) may be configured to perform a method 410, such as the process associated with sequence diagram 300 or the process 600 of FIG. 6, described in more detail below, for example. In another embodiment, the set of computer instructions 412 may be configured to implement a system or platform, such as verification server 110 described with respect to FIG. 1, for example. Many such computer-readable media may be devised by those of ordinary skill in the art that are configured to operate in accordance with the techniques presented herein.

As used in this application, the terms “component,” “module,” “system,” “interface,” “manager,” “engine,” and the like are generally intended to refer to a computer-related entity, either hardware, a combination of hardware and software, software, or software in execution. For example, a component may be, but is not limited to being, a process running on a processor, a processor, an object, an executable, a thread of execution, a program, or a computer. By way of illustration, both an application running on a controller and the controller may be a component. One or more components residing within a process or thread of execution and a component may be localized on one computer or distributed between two or more computers.

A device may also be called and may contain some or all of the functionality of a system, subscriber unit, subscriber station, mobile station, mobile, mobile device, wireless terminal, device, remote station, remote terminal, access terminal, user terminal, terminal, wireless communication device, wireless communication apparatus, user agent, user device, or user equipment (UE). A mobile device may be a cellular telephone, a cordless telephone, a Session Initiation Protocol (SIP) phone, a smart phone, a feature phone, a wireless local loop (WALL) station, a personal digital assistant (PDA), a laptop, a handheld communication device, a handheld computing device, a netbook, a tablet, a satellite radio, a data card, a wireless modem card, and/or another processing device for communicating over a wireless system. Further, although discussed with respect to wireless devices, the disclosed aspects may also be implemented with wired devices, or with both wired and wireless devices.

Further, the claimed subject matter may be implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

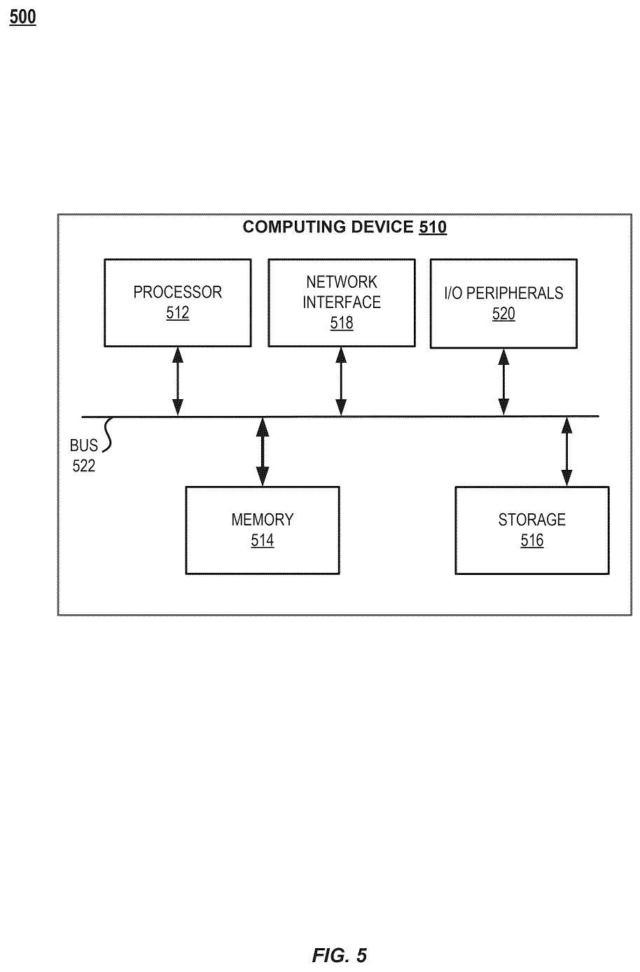

Turning now to FIG. 5, which depicts an example of a computing environment 500 for implementing examples of one or more aspects of the present disclosure. The computing environment 500 of FIG. 5 is merely one example of a suitable operating environment configured to implement a verification server 110, for example, and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, mini-computers, mainframe computers, distributed computing environments that include any of the above systems or devices, etc.

Generally, embodiments are described in the general context of “computer readable instructions” being executed by one or more computing devices. Computer readable instructions may be distributed via computer readable media as will be discussed below. Computer readable instructions may be implemented as program modules, such as functions, objects, APIs, data structures, and the like, which perform one or more tasks or implement one or more abstract data types. Typically, the functionality of the computer readable instructions is combined or distributed as desired in various environments.

FIG. 5 is a block diagram illustrating an example computing device 510 configured to validate AI agents by verifying AI agent identity using blockchains, according to one or more aspects of the present disclosure. In one configuration, the computing device 510 may include at least one processor 512 and at least one memory 514. Depending on the exact configuration and type of computing device, the at least one memory 514 may be volatile, such as RAM, non-volatile, such as ROM, flash memory, etc., or a combination thereof. Examples of processor 512 include a microprocessor, an application-specific integrated circuit (ASIC), a field-programmable gate array (FPGA), or any other suitable processing device. Computing device 510 can include one processor, such as is illustrated by processor 512 in FIG. 5, or more than one processor. Memory 514 may store other programs and data not specifically identified herein.

Computing device 510 may include additional features or functionality. For example, the computing device 510 may include storage such as removable storage or non-removable storage, including, but not limited to, magnetic storage, optical storage, etc. Such storage is illustrated in FIG. 5 by storage 516. In one or more embodiments, computer readable instructions to implement one or more embodiments provided herein are in the storage 516. The storage 516 may store other computer readable instructions to implement an operating system, an application program, etc. Computer readable instructions may be loaded in the at least one memory 514 for execution by the at least one processor 512, for example.

Computing devices may include a variety of media, which may include computer-readable storage media or communications media, which two terms are used herein differently from one another as indicated below.

Computer-readable storage media may be any available storage media, which may be accessed by the computer and includes both volatile and nonvolatile media, removable and non-removable media. By way of example, and not limitation, computer-readable storage media may be implemented in connection with any method or technology for storage of information such as computer-readable instructions, program modules, structured data, or unstructured data. Computer-readable storage media may include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which may be used to store desired information. Computer-readable storage media may be accessed by one or more local or remote computing devices (e.g., via access requests, queries, or other data retrieval protocols) for a variety of operations with respect to the information stored by the medium.

Communications media typically embody computer-readable instructions, data structures, program modules, or other structured or unstructured data in a data signal such as a modulated data signal (e.g., a carrier wave or other transport mechanism) and includes any information delivery or transport media. The term “modulated data signal” (or signals) refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

Still referring to FIG. 5, the computing environment 500 may also include a number of additional external or internal devices, for example, input or output devices. For example, computing device 510 is illustrated as including input/output (I/O) peripherals 520. I/O peripherals 520 can receive input from an input device (not shown) or provide output to output devices (not shown). Input peripherals can include a variety of different input devices such as keyboards, mouses, pens, voice input devices, touch input devices, infrared cameras, video input devices, or any other input device. Output peripherals can include a variety of different output devices such as one or more displays, speakers, printers, or any other output device may be included with the computing device 510.

I/O peripherals 520 may be connected to the computing device 510 via a wired connection, wireless connection, or any combination thereof. Further, the computing device 510 may include network interface 518 to facilitate communications with one or more other devices (not shown). Network interface 518 can include any device or group of devices suitable for establishing a wired or wireless data connection to one or more data networks. Non-limiting examples of the network interface 518 include an Ethernet network adaptor, a wireless network adapter, a modem, Wi-Fi adapter, Bluetooth adapter, near field communication (NFC) receiver and transmitter, and any other known wired or wireless data transmission system. Computing device 510 also includes bus 522. Although only one interface bus is illustrated, computing environment 500 can include more than one interface bus. Bus 522 can communicatively couple one or more components of the computing device 510.

### Example Methods for Verifying AI Agent Identity Using Blockchains

Turning now to FIG. 6, which is a flowchart illustrating an example process 600 for verifying AI agent identity using a ledger network, according to one or more aspects of the present disclosure. The process 600 will be described with respect to the computing environment 100 shown in FIG. 1, the ledger network 190 shown in FIG. 2, and the sequence diagram 300 shown in FIG. 3; however, any suitable system or platform according to this disclosure may be employed, including the example computing device 510 shown in FIG. 5. Additionally, process 600 is provided in the order shown, but other orders or additional steps may be provided.

As shown in FIG. 6, the process 600 begins at step 602 where the verification server 110 receives a communication via an application of a third-party computing device. The communication may be associated an artificial intelligence (AI) agent requesting to perform an action on behalf of a user. In some implementations, the communication comprises a unique user identifier 122 and an AI agent OID 123. In some implementations, the communication can also comprise a reference to a particular block of a blockchain. In some implementations, the communication can include a reference to a certificate associated with the user who provisioned the AI agent, where user identity information and AI agent identity information are encoded into the certificate. In these examples, the certificate can include a public key associated with the user.

Next at step 604, the verification server 110 extracts the unique user identifier 122 and the AI agent OID 123 from the communication. In some examples, extraction of the unique user identifier 122 and the AI agent OID 123 can be performed via accessing a certificate associated with the user in a data storage unit 150. In these examples, the verification server 110 can extract the unique user identifier 122, the AI agent OID 123, and a public key from the certificate.

Next at step 606, the verification server 110 accesses a distributed ledger 190 indicating relationships between unique user identifiers and OID credentials assigned to the unique user identifiers. In some examples, the distributed ledger 190 is a blockchain. In some examples, the distributed ledger 190 can include more than one blockchain, such as blockchain 140, blockchain 141,. blockchain n. Each blockchain in the distributed ledger 190 may be referred to as “ledgers,” “distributed ledgers,” “chains,” or “digital ledgers.” The blockchains each include a series of sequential, immutable entries, referred to as “blocks,” where each block is distinct from the block before it, but linked to the prior block via a block ID, such as a hashed pointer, thereby creating sequential chain of blocks or “blockchain.” The blockchains can serve as trusted records that can be relied above by verification server 110 and third party computing devices 130a-n to validate the communication and manage negative AI agent behavior.

Then at step 608, the verification server 110 verifies an identity of the AI agent by determining if the information contained in the communication (e.g., AI Agent OID 123 and unique user identifier 122) is correlated to the one or more blocks in the distributed ledger 190. For example, if the verification server 110 determines that the communication received from the AI agent(s) 170 and the certificate extracted from the data storage unit 150, are signed with the same digital signature, the verification server 110 can determine that the communication is authenticate and the AI agent identity is verified. In some examples, verifying the AI agent identity can involve evaluating the request(s) 171 and determining that the digital signature in the request(s) 171 matches the digital signature in the user attributes block of the blockchain 140, without requiring access of the certificate. In some examples, verifying the identity of the AI agent can involve determining that blocks from separate blockchains in the distributed ledger comprise correlated identity information. More specifically, a user attributes block of blockchain 140 includes correlated identity information to AI agent attributes from blockchain 141 where the blocks from respective blockchains are identified based on the user identifier 122 and AI agent OID 123 from the original communication. In some examples, verifying the identity of the AI agent can involve evaluating a verification flag in an entry in blockchain 141, for example in cases where the communication is a periodic communication (e.g., signifying repeated actions performed by the AI agent).

Next at step 610, the verification server 110 transmits a control signal to a relying party computing system 130 comprising an indication that the AI agent is verifiable and an instruction to execute the action. Alternatively, if the AI agent is not verifiable, the verification server 110 can deny the request of the AI agent to perform the action. In some examples, after denying the request in the communication, the verification server 110 can transmit a response signal indicating the denial to the originating computing device (e.g., the computing device that originally transmitted the communication). In some examples, as in the case where the AI agent is verifiable, the verification server 110 can transmit a response signal indicating success of the action to the originating computing device.

### General Considerations

Numerous specific details are set forth herein to provide a thorough understanding of the claimed subject matter. However, those skilled in the art will understand that the claimed subject matter may be practiced without these specific details. In other instances, methods, apparatuses, or computing systems that would be known by one of ordinary skill have not been described in detail so as not to obscure claimed subject matter.

Unless specifically stated otherwise, it is appreciated that throughout this specification discussions utilizing terms such as “generating,” “processing,” “computing,” and “determining” or the like refer to actions or processes of a computing device, such as one or more computers or a similar electronic computing device or devices that manipulate or transform data represented as physical electronic or magnetic quantities within memories, registers, or other information storage devices, transmission devices, or display devices of the computing platform.

The computing system or computing systems discussed herein are not limited to any particular hardware architecture or configuration. A computing device can include any suitable arrangement of components that provide a result conditioned on one or more inputs. Suitable computing devices include multi-purpose microprocessor-based computer systems accessing stored software that programs or configures the computing system from a general-purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Various operations of embodiments are provided herein. The order in which one or more or all of the operations are described should not be construed as to imply that these operations are necessarily order dependent. Alternative ordering will be appreciated based on this description. Further, not all operations may necessarily be present in each embodiment provided herein.

As used in this application, “or” is intended to mean an inclusive “or” rather than an exclusive “or.” Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes,” “having,” “has,” “with,” or variants thereof are used in either the detailed description or the claims, such terms are intended to be inclusive in a manner similar to the term “comprising.” The use of “configured to” or “based on” herein is meant as open and inclusive language that does not foreclose devices adapted to or configured to perform additional tasks or steps. The endpoints of comparative limits are intended to encompass the notion of quality. Thus, expressions such as “more than” should be interpreted to mean “more than or equal to.”

Where devices, computing systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation and does not preclude inclusion of such modifications, variations, and/or additions to the present subject matter as would be readily apparent to one of ordinary skill in the art.

What is claimed is:

1. A digital distributed ledger-based system comprising:
one or more processors; and
a memory coupled to the one or more processors, the memory including instructions that, when executed by the one or more processors, cause the one or more processors to:
receive a communication via an application of a computing device, the communication being associated with an artificial intelligence (AI) agent requesting to perform an action on behalf of a user;
extract a unique user identifier and an Object Identifier (OID) of the AI agent from the communication;
access a distributed ledger indicating relationships between unique user identifiers and OID credentials assigned to the unique user identifiers;
verify an identity of the AI agent by determining if the OID of the AI agent is correlated to the unique user identifier in the distributed ledger; and
transmit a control signal to a relying party computing system comprising an indication that the AI agent is verifiable and an instruction to execute the action.

2. The digital distributed ledger-based system of claim 1, wherein the communication comprises a reference to a certificate associated with the user, wherein the unique user identifier and the OID of the AI agent are encoded into the certificate, wherein the certificate includes a public key, and wherein the one or more processors are further configured to:
access the certificate via the reference;
extract the unique user identifier, the OID of the AI agent, and the public key from the certificate;
retrieve, from the distributed ledger, identity information associated with the AI agent; and
determine whether the identity information associated with the AI agent is signed using the public key extracted from the certificate.

3. The digital distributed ledger-based system of claim 1, wherein the distributed ledger is a blockchain.

4. The digital distributed ledger-based system of claim 1, wherein the one or more processors are further configured to:
deny, responsive to a verification process of the identity of the AI agent failing, the request of the AI agent to perform the action.

5. The digital distributed ledger-based system of claim 1, wherein the distributed ledger comprises a plurality of entries associated with a plurality of users, wherein each entry in the distributed ledger includes (i) a respective unique user identifier, (ii) a plurality of OIDs associated with respective AI agents, (iii) a reference to a certificate comprising a public key, and (iv) a verification flag field associated with each OID, wherein the communication is a first communication, and wherein the one or more processors are further configured to:
generate a new entry in the distributed ledger comprising an updated verification flag field responsive to verifying the identity of a respective AI agent;
receive a second communication associated with the respective AI agent requesting to perform a second action on behalf of the user; and
verify the identity of the respective AI agent by evaluating the verification flag field.

6. The digital distributed ledger-based system of claim 5, wherein the action is performed periodically by the respective AI agent, wherein verifying the identity of the respective AI agent for each subsequent communication after the first communication includes evaluating the verification flag field.

7. The digital distributed ledger-based system of claim 1, wherein the one or more processors are further configured to:
transmit a response signal to the user comprising a notification that the action was performed successfully and a description indicating that the action was performed by the AI agent.

8. A computer-implemented method comprising:
receiving, by a processor, a communication via an application of a third-party computing device, the communication being associated with an artificial intelligence (AI) agent requesting to perform an action on behalf of a user;
extracting, by the processor, a unique user identifier and an Object Identifier (OID) of the AI agent from the communication;
accessing, by the processor, a distributed ledger indicating relationships between unique user identifiers and OID credentials assigned to the unique user identifiers;
verifying, by the processor, an identity of the AI agent by determining if the OID of the AI agent is correlated to the unique user identifier in the distributed ledger; and
transmitting, by the processor, a control signal to a relying party computing system comprising an indication that the AI agent is verifiable and an instruction to execute the action.

9. The computer-implemented method of claim 8, wherein the communication comprises a reference to a certificate associated with the user, wherein the unique user identifier and the OID of the AI agent are encoded into the certificate, wherein the certificate includes a public key, and wherein the method further comprises:
accessing, by the processor, the certificate via the reference;
extracting, by the processor, the unique user identifier, the OID of the AI agent, and the public key from the certificate;
retrieving, by the processor and from the distributed ledger, identity information associated with the AI agent; and
determining, by the processor, whether the identity information of associated with the AI agent is signed using the public key extracted from the certificate.

10. The computer-implemented method of claim 8, wherein the distributed ledger is a blockchain.

11. The computer-implemented method of claim 8, further comprising:
denying, by the processor and responsive to a verification process of the identity of the AI agent failing, the request of the AI agent to perform the action.

12. The computer-implemented method of claim 8, wherein the distributed ledger comprises a plurality of entries associated with a plurality of users, wherein each entry in the distributed ledger includes (i) a respective unique user identifier, (ii) a plurality of OIDs associated with respective AI agents, (iii) a reference to a certificate comprising a public key, and (iv) a verification flag field associated with each OID, wherein the communication is a first communication, and wherein the method further comprises:
generating, by the processor, a new entry in the distributed ledger comprising an updated verification flag field responsive to verifying the identity of a respective AI agent;
receiving, by the processor, a second communication associated with the respective AI agent requesting to perform a second action on behalf of the user; and
verifying, by the processor, the identity of the respective AI agent by evaluating the verification flag field.

13. The computer-implemented method of claim 12, wherein the action is performed periodically by the respective AI agent, wherein verifying the identity of the respective AI agent for each subsequent communication after the first communication includes evaluating the verification flag field.

14. The computer-implemented method of claim 8, further comprising:
transmitting, by the processor, a response signal to the user comprising a notification that the action was performed successfully and a description indicating that the action was performed by the AI agent.

15. A non-transitory computer-readable medium embodying program code that is executable by one or more processors to cause the one or more processors to:
receive a communication via an application of a third-party computing device, the communication being associated with an artificial intelligence (AI) agent requesting to perform an action on behalf of a user;
extract a unique user identifier and an Object Identifier (OID) of the AI agent from the communication;
access a distributed ledger indicating relationships between unique user identifiers and OID credentials assigned to the unique user identifiers;
verify an identity of the AI agent by determining if the OID of the AI agent is correlated to the unique user identifier in the distributed ledger; and
transmit a control signal to a relying party computing system comprising an indication that the AI agent is verifiable and an instruction to execute the action.

16. The non-transitory computer-readable medium of claim 15, wherein the communication comprises a reference to a certificate associated with the user, wherein the unique user identifier and the OID of the AI agent are encoded into the certificate, wherein the certificate includes a public key, and wherein the one or more processors are further configured to:
access the certificate via the reference;
extract the unique user identifier, the OID of the AI agent, and the public key from the certificate;
retrieve, from the distributed ledger, identity information associated with the AI agent; and
determine whether the identity information of associated with the AI agent is signed using the public key extracted from the certificate.

17. The non-transitory computer-readable medium of claim 15, wherein the distributed ledger comprises a plurality of entries associated with a plurality of users, wherein each entry in the distributed ledger includes (i) a respective unique user identifier, (ii) a plurality of OIDs associated with respective AI agents, (iii) a reference to a certificate comprising a public key, and (iv) a verification flag field associated with each OID, wherein the communication is a first communication, and wherein the one or more processors are further configured to:
generate a new entry in the distributed ledger comprising an updated verification flag field responsive to verifying the identity of a respective AI agent;
receive a second communication associated with the AI agent requesting to perform a second action on behalf of the user; and
verify the identity of the AI agent by evaluating the verification flag field.

18. The non-transitory computer-readable medium of claim 17, wherein the action is performed periodically by the AI agent, wherein verifying the identity of the AI agent for each subsequent communication after the first communication includes evaluating the verification flag field.

19. The non-transitory computer-readable medium of claim 15, wherein the one or more processors are further configured to:
transmit a response signal to the user comprising a notification that the action was performed successfully and a description indicating that the action was performed by the AI agent.

20. The non-transitory computer-readable medium of claim 15, wherein the distributed ledger is a blockchain, and wherein the one or more processors are further configured to:
deny, responsive to a verification process of the identity of the AI agent failing, the request of the AI agent to perform the action.
